(19) United States
(12) Patent Application Publication
(10) Pub. No.: US 2008/0014865 A1
(43) Pub. Date: Jan. 17, 2008

(54) Radio and public address accessory system with wireless interface

(75) Inventors: James Roberts, Belmont, CA (US); David Fettig, Fremont, CA (US)

Correspondence Address: MINTZ, LEVIN, COHN, FERRIS, GLOVSKY AND POPEO, P.C, 1400 PAGE MILL ROAD, PALO ALTO, CA, 94304-1124, US

(73) Assignee: Pinnacle Peak Holding Corporation (dba Setcom Corp.), Mountain View, CA (US)

(21) Appl. No.: 11/820,345

(22) Filed: Jun. 18, 2007

Related U.S. Application Data
(60) Provisional application No. 60/814,176, filed on Jun. 16, 2006.

(51) Int. Cl. H04B 7/15

(52) U.S. Cl. 455/11.1

(57) ABSTRACT

A communications system for a vehicle user is provided. The system comprises a portable transceiver which the vehicle user can easily carry on his or her person and a vehicle-mounted transceiver. The portable transceiver is capable of communicating with the vehicle-mounted transceiver. Audio information contained in a transmission from the portable transceiver may be retransmitted by the vehicle-mounted transceiver either to a public address system or a second vehicle-mounted transceiver.

### CROSS-REFERENCE TO RELATED APPLICATIONS

This application claims priority to U.S. Provisional Patent Application No. 60/814,176, filed Jun. 16, 2006, which is incorporated by reference.

### TECHNICAL FIELD

This invention relates generally to mobile radio systems.

### BACKGROUND

In the spectrum of motor vehicle passenger safety, motorcycles are some of the most dangerous vehicles on the road. This danger only increases when a motorcycle rider takes his/her hands off of the handlebars to use a communications device. When you apply this to the job of a law enforcement motorcycle officer, the risk of injury only increases because officers are constantly using communication devices while riding. Enabling riders to keep their hands on the handlebars while riding is an important safety requirement. Moreover, most jurisdictions require by law that motorcyclists keep both hands on the handlebars.

Law enforcement motorcycles have a number of different radio configurations which can include a combination of portable radios and mobile radios.

Portable Radio. This type of two-way radio is typically worn on the officer's belt and is typically low power with its transceiver being able to have between 3 and 5 watts of power. Portable radios work well in situations where the patrol area is limited and the geographical features of the area are fairly flat.

Mobile Radio. This type of two-way radio is mounted on the motorcycle in the radio box that is on the back of the bike. This radio has more range than a portable radio because it has greater power. The typical wattage of a motorcycle mobile radio is 15 watts. Mobile radios typically cost 3×-5× as much as a portable radio and work well when the patrol area is over a large area and/or the terrain is hilly or has significant obstructions.

In addition to the radios, often a public address (PA) system is installed on the motorcycle. Through a loudspeaker, this system is used to audibly broadcast instructions or information to violators or the general public in a limited area.

Since 1970, there have been a number of offerings in the marketplace to allow motorcycle officers the ability to operate their radios and public address systems without having to take their hands off the handlebars.

These offerings typically include additional equipment on a motorcycle, such as a radio push-to-talk (PTT) button mounted on the handlebar. Pressing the PTT keys the radio and allows the officer to transmit communication. For the PA system, an additional button is also mounted on the handlebar which when pressed, broadcasts the officer's speech over the PA system.

On the officer, these offerings typically include a boom microphone and speakers that are mounted on/in the helmet.

In between the motorcycle and officer, historically, a wire with a quick release connector has been used to connect the officer worn equipment to bike mounted equipment. This wire carries the inbound and outbound transmissions over the mobile radio and also allows for the keying of the radio.

Others have invented wireless interfaces between communication devices and riders. In general, however, these systems have lacked features. The following are some examples of desirable features: (a) Allowing the rider to both receive and transmit over the mobile radio while on the motorcycle. (b) Operating solely off of the motorcycle battery and the portable radio battery. No additional charging of batteries is required. (c) Having the ability to remotely and wirelessly operate the PA system while a significant distance (e.g., 50 feet) from the motorcycle. (d) Not requiring a rider to pair or sync his on-person equipment with the equipment on the motorcycle. (e) Not requiring locking connectors, which greatly increases rider safety. (f) Having the ability to operate in a wired mode if the wireless connection should fail. (g) Having side tone, which increases the ease of communication for the rider.

### SUMMARY OF THE INVENTION

This invention relates to a radio accessory system, specifically to a system that is on a vehicle and worn on a person and interfaces radios, speakers, microphones, and public address systems. The interface between the part of the system that is on the vehicle and the other part that is worn on a person is wireless. The intent of the invention is to reduce the distraction of operating communications devices while operating a vehicle thus increasing the safety of a vehicle's users while also enabling the use of communication devices.

In an embodiment of the invention, a communications system for a vehicle user is provided. The system comprises a portable transceiver which the vehicle user can easily carry on his or her person and a vehicle-mounted transceiver. The portable transceiver is capable of communicating with the vehicle-mounted transceiver. Audio information contained in a transmission from the portable transceiver may be retransmitted by the vehicle-mounted transceiver either to a public address system or a second vehicle mounted transceiver.

In a further embodiment of the invention, a method of communicating for a vehicle user is provided. By means of a first transceiver mounted on a vehicle used by the user, a first radio signal containing audio information is received. The first radio signal is transformed to produce a second radio signal containing substantially the same audio information. By means of a portable transceiver mounted on the user's person, the second radio signal is received and demodulated it to produce an audio signal. At least one speaker is energized with the audio signal so that the user perceives audio information contained in the first radio signal. By means of a microphone additional audio information resulting from words said by the user is captured. By means of the portable transceiver, a third radio signal containing the audio information resulting from words said by the user is generated. In response to the third radio signal, either playing the audio information in the third radio signal on a public address system, or transmitting that audio information in a fourth radio signal.

### FIGURES

FIG. 1 is a representation of an operator on a vehicle using the system.

FIG. 2 is a representation of an operator off and away from the vehicle using the system and the remote PA feature.

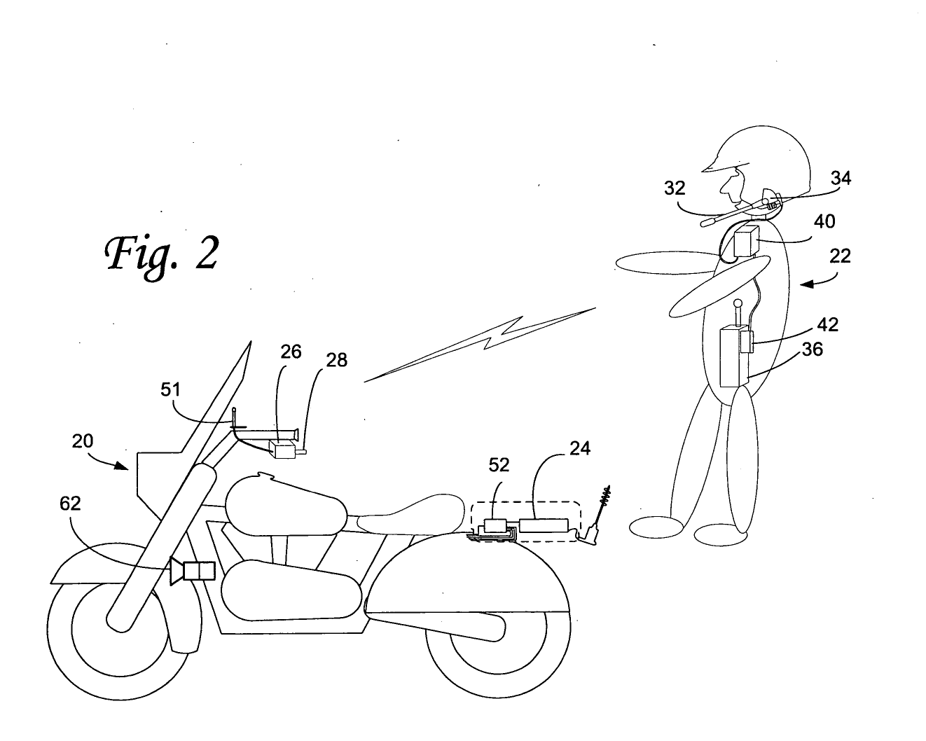

FIG. 3 is a representation of the system without it being on a vehicle and the operator.

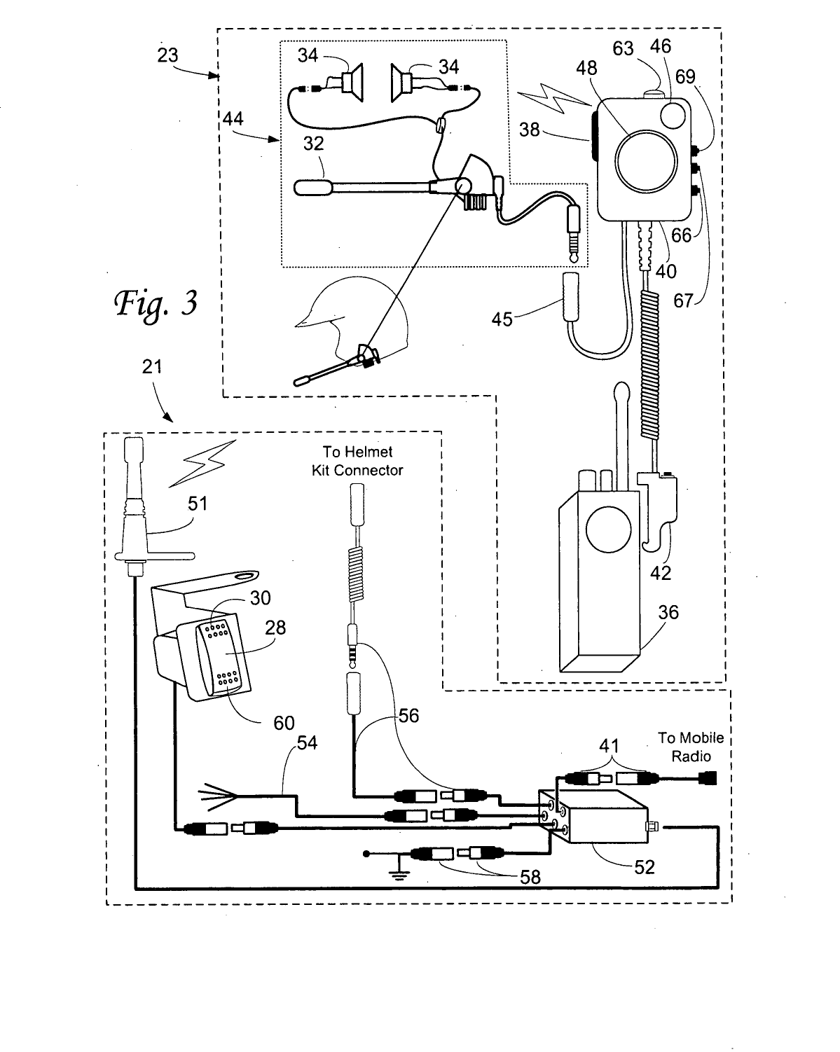

FIG. 4 is a system schematic of the vehicle module assembly.

FIG. 5 is a system schematic of the operator module assembly.

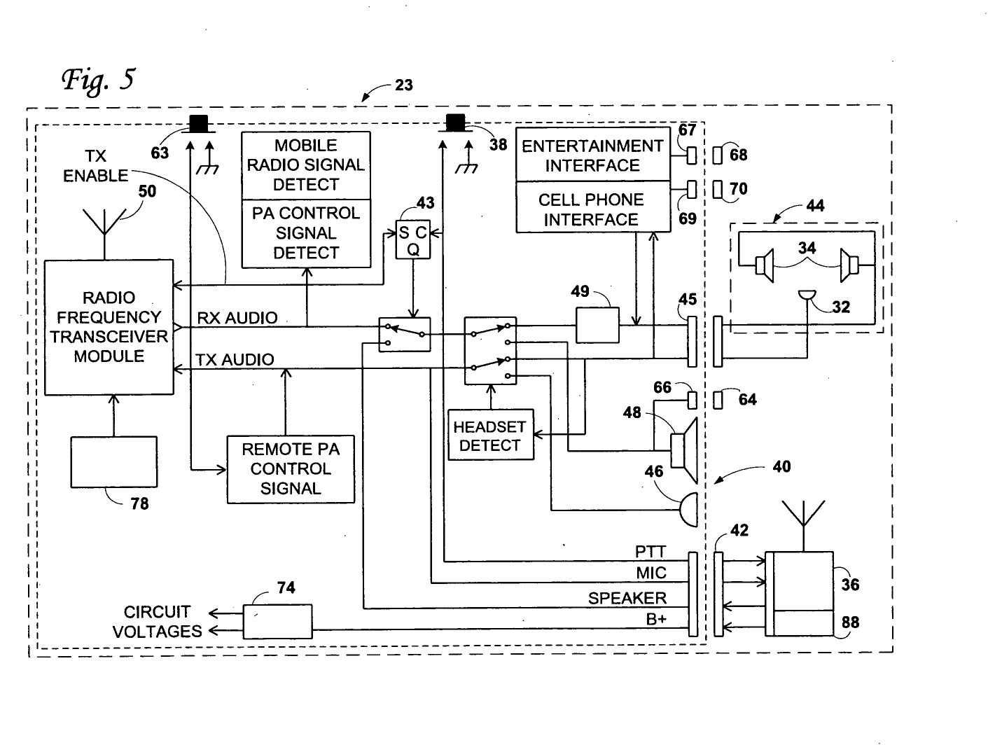

### DETAILED DESCRIPTION OF PREFERRED EMBODIMENTS

[Standard Preliminaries and Express Definitions]

Before describing the present invention in detail, it is to be understood that this invention is not limited to specific solvents, materials, or device structures, as such may vary. It is also to be understood that the terminology used herein is for the purpose of describing particular embodiments only, and is not intended to be limiting.

As used in this specification and the appended claims, the singular forms “a,” “an,” and “the” include both singular and plural referents unless the context clearly dictates otherwise. Thus, for example, reference to “an active ingredient” includes a plurality of active ingredients as well as a single active ingredient, reference to “a temperature” includes a plurality of temperatures as well as single temperature, and the like.

In the following a preferred embodiment of the invention is described.

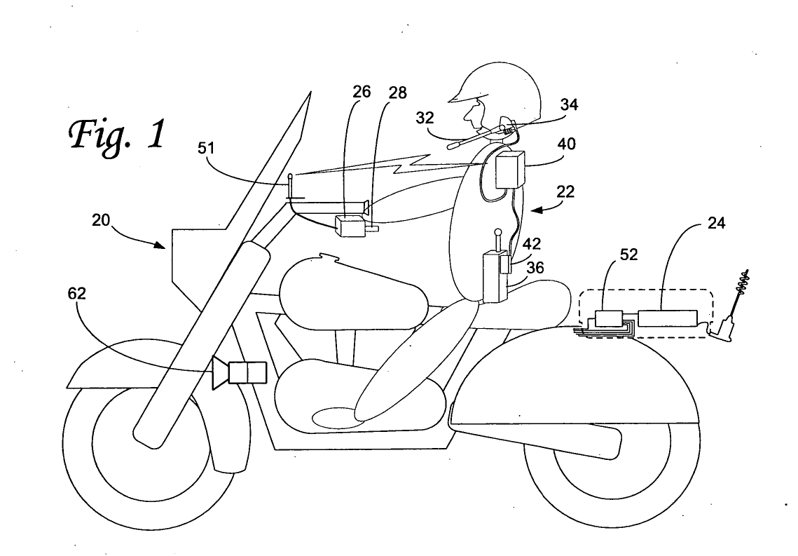

FIG. 1 shows a radio system comprised of the equipment permanently affixed to the vehicle 20 (vehicle module assembly 21) and removable equipment worn and controlled by the operator 22 (operator module assembly 23). This system allows the operator 22 to communicate to a distant radio through the vehicle mobile radio 24 by pressing the steering bar 26 mounted switch 28 to the radio push-to-talk (PTT) position 30 and speaking into the microphone 32. When the operator 22 releases the PTT switch 28, the operator 22 will receive any inbound communications from the mobile radio 24 thought the speaker(s) 34. If the operator 22 exits the vehicle 20, the operator 22 can communicate to a distant radio using the portable radio 36 attached to his person by pressing the PTT switch 38 on the speaker-microphone 40. When the operator 22 releases the PTT switch 38, the operator 22 will receive any inbound communications from the portable radio 36 through the speaker(s) 34.

By pressing either the steering bar switch 28 to the PTT position 30, or the speaker-microphone PTT switch 38, the operator 22 automatically selects which radio system with which he wishes communicate. By pressing the steering bar switch 28 to the PTT position 30, all inbound and outbound communications will be established via the mobile radio 24. The mobile radio 24 is connected to the vehicle module assembly 21 through a mobile radio connector assembly 41 which varies in design depending on the type of mobile radio 24. Alternately, by pressing the speaker-microphone PTT switch 38, the operator 22 will switch all inbound and outbound communications to the portable radio 36. The portable radio 36 is connected to the operator module assembly 23 through a portable radio adaptor 42 which varies in design depending on the type of portable radio 36.

Pressing the steering bar 26 mounted switch 28 to the radio push-to-talk (PTT) position 30 enables a mobile mode signaling command from the vehicle module 21 to the speaker-microphone 40. This sets an internal flip-flop 43 that switches internal circuitry within the speaker microphone 40 into the mobile mode. When the system is in the mobile mode, the mobile radio's 24 inbound and outbound transmissions are routed to the headset 44. The headset is comprised of the speaker(s) 34 and microphone 32. When the headset 44 is connected to the speaker-microphone 40, a sidetone feature is enabled sending a small amount of the microphone signal back into the speaker(s) 34 so the operator 22 hears a little bit of his speech for enhanced aural feedback. The operator 22 has the option to disconnect the headset 44 from the speaker-microphone 40 and in doing so the headset 44 functions are automatically switched to a self-contained internal microphone 46 and speaker 48 within the speaker-microphone 40. The sidetone feature is only functional with the headset 44 connected to the speaker-microphone 40.

When operating in the mobile wireless mode, the operator 22 has a transmit and receive audio link established from the speaker-microphone 40 to the vehicle module assembly 21. This wireless communication path is radiated from an antenna 50 within the speaker-microphone 40, to an antenna 51 affixed to the vehicle 20. The vehicle antenna 51 is connected to the vehicle control module 52 located within the vehicle 20. The steering bar switch 28, public address (PA) cable assembly 54, wired-backup cable assembly 56, and vehicle power cable 58, are additional cables routing power and control signals to the vehicle control module 52.

When the operator 22 momentarily presses or locks the steering bar switch 28 to the PA position 60, the wireless signal from the headset microphone 32 is transmitted to the vehicle control module 52 and is rebroadcast to the vehicle public address system 62. When in remote PA mode, the remote PA feature is operational at considerable distance away from the vehicle 20. The PA mute button 63 when pressed, mutes the PA system until the PA mute button 63 is released. This PA mute button 63 can be a momentary or locking switch.

The speaker-microphone 40 has three optional audio interfaces. First, the operator 22 can plug in an ear bud speaker 64 and privately monitor incoming radio transmissions. When inserted into the port 66 in the speaker-microphone 40, the ear bud speaker 64 would mute the speaker-microphone's speaker 48. Second, the operator 22 can plug into the personal entertainment device port 67 a device 68 such as a CD player or transistor radio that is summed with incoming radio transmissions. Third, the operator 22 can plug into the cellular telephone port 69 a cellular telephone 70 that is summed with incoming radio transmissions and outbound cellular telephone conversation can be accomplished through the headset microphone 32.

Internal within the vehicle control module 52 are voltage regulators 72 that step down the vehicle's volt system to voltage levels appropriate for internal circuitry. In the speaker-microphone 40 are voltage regulators 74 that step down the portable radio's 36 power source to voltage levels appropriate for the speaker-microphone's 40 internal circuitry.

Within both the vehicle control module 52 and the speaker-microphone 40 are binary switches 76, 78 that allow the manual selection of numerous discrete RF frequencies for dedicated individual wireless links so operators with similar equipment will not interfere with each other. The operator 22 also has the ability to automatically increment though discrete RF frequencies to establish a clear channel.

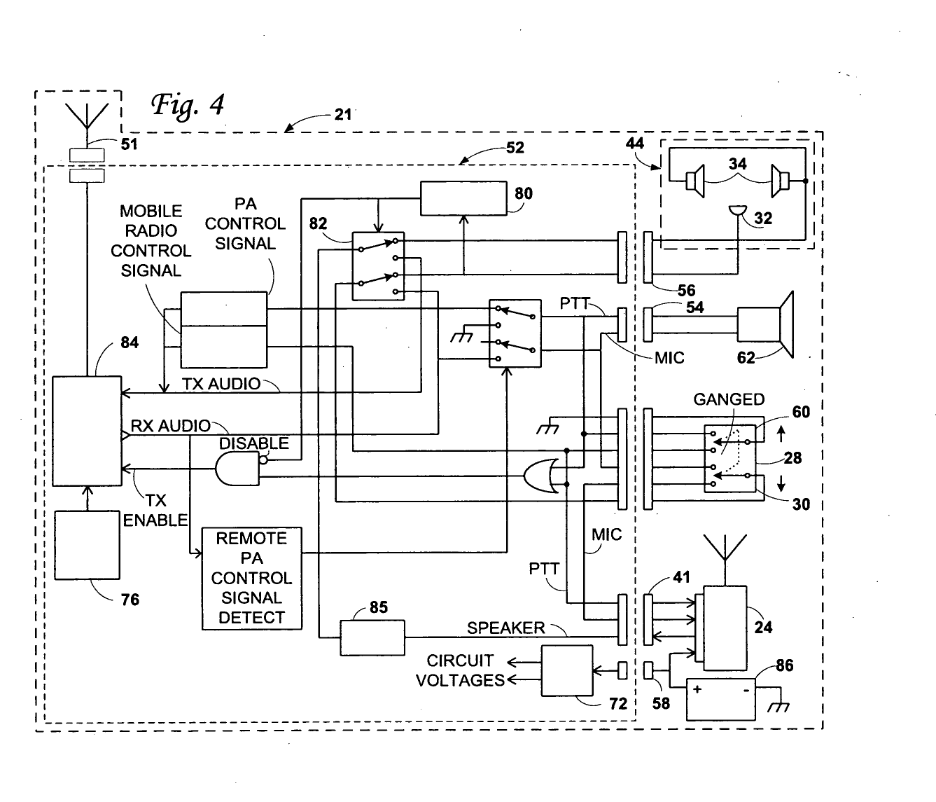

The operator 22 has the option to connect his headset 44 to the vehicle control module's 52 wired-backup cable assembly 56 thus allowing a conventional wired signal path from the headset 44 directly to the mobile radio 24. This feature could be used in the event the wireless system should fail. Within the vehicle control module 52, is a detection circuit 80 (shown in FIG. 4) that senses that the wired-backup cable assembly 56 is connected to the headset 44. This connection activates a relay 82 within the vehicle control module 52 that directly routes the headset's 44 speaker(s) 34 and microphone 32 to the mobile radio 24. Also, the detection circuit 80 disables the vehicle control module transceiver 84 transmit function to prevent superfluous wireless transmissions. In this wired mode, the vehicle steering bar PTT and PA switch 28 still activate the mobile radio 24 and vehicle public address system 62, respectively.

When the operator 22 exits the vehicle 20 and wishes to have inbound and outbound communications established via the portable radio 36, the operator 22 only needs to press the PTT switch 38 on the speaker microphone 40. When this PTT button 38 is pressed an internal flip flop 42 within the speaker microphone 40 is reset which switches internal circuitry into the portable radio mode. When operating in the portable radio mode, the PTT switch 38, speaker microphone 40, or headset 44, will be directly connected to the portable radio 36. The sidetone feature is functional when the headset 44 is connected to the speaker microphone 40.

In certain embodiments of the invention, the operator is able to simultaneously hear the audio streams from the portable radio 36 as well as the mobile radio 24 in the vehicle operator's 22 headset speaker(s) 34 or speaker-microphone speaker 48. The operator module assembly 23 takes the multiple audio streams and sums them such that both audio streams are simultaneously sent to the headset speakers 34. By adjusting the volume of either radio, the operator can hear one stream more loudly or softly or the at the same volume level as the other radio. Transmitting over either radio is accomplished as described above. No different technique is required to transmit.

The operation of an embodiment of the invention is now described:

A. On/In Vehicle

While operating the vehicle 20, the operator 22 receives from and transmits to the mobile radio 24. Keying the mobile radio 24 is accomplished by pressing the switch 28 mounted on the steering bar 26 of the vehicle 20 to the radio push-to-talk (PTT) position 30. Once the switch 28 is pressed to the PTT position 30, the operator 22 speaks into the headset microphone 32. When speaking, the operator 22 hears sidetone through the speaker(s) 34. Sidetone is when the operator can hear his own voice through the speaker(s) 34 when he transmits. This helps the brain process speech when communicating, particularly in high noise environments. The operator's speech is transmitted from the mobile radio 24.

To use the vehicle PA system 62, the operator 22 presses the switch 28 to the PA position 60. The operator speaks into the headset microphone 32. When speaking, the operator 22 hears sidetone through the headset speaker(s) 34. The operator's speech is transmitted through the PA system 62.

When the operator 22 is not transmitting, inbound transmissions on the mobile radio 24 are heard by the operator 22 through the headset speaker(s) 34.

If the operator 22 prefers to have a wired connection to the system instead of the wireless connection, the operator 22 takes the wired-backup cable assembly 56 and plugs it directly into the headset 44. In the wired mode, the system works the same as described above except that there is a physical wired connection between the operator module assembly 23 and vehicle module assembly 21.

B. Out/Off of Vehicle

When the operator 22 exits the vehicle 20, the operator 22 will continue to hear inbound transmissions from the mobile radio 24 until the operator 22 is out of range or the operator 22 presses PTT button 38 on the speaker-microphone 40. Pressing the speaker-microphone PTT switch 38 switches the system from transmitting and receiving on the mobile radio 24 to transmitting and receiving on the portable radio 36. To go back to transmitting and receiving over the mobile radio 24, the operator 22 must press the switch 28 mounted on the steering bar 26 of the vehicle 20 to the PTT position 30. From this point, until the PTT switch 28 on the speaker-microphone 40 is pressed again, the system will be in mobile radio mode and all transmissions will be transmitted to and received from the mobile radio 24.

When pressing the speaker-microphone PTT button 38 and the headset 44 is connected to the speaker-microphone 40, the operator 22 speaks into the headset microphone 32 and the operator's speech is transmitted through the portable radio 36. When transmitting, the operator 22 hears sidetone through the speaker(s) 34. When not transmitting and the headset 44 is connected to the speaker-microphone 40, all transmissions received by the portable radio 36 are heard through the speaker(s) 34 and the speaker 48 in the speaker-microphone 40 is muted. This is called the auto mute function.

When the headset 44 is not connected to the speaker-microphone 40, the speaker-microphone auto mute function is turned off and transmissions from the portable radio 36 are broadcast through the speaker-microphone's speaker 48. When the headset 44 is not connected to the speaker-microphone 40 and the operator 22 pushes the PTT button 38 on the speaker-microphone, the operator 22 speaks into the speaker-microphone microphone 46. The operator's speech is transmitted through the portable radio 36.

To operate the vehicle PA system 62 remotely, the operator 22 presses the switch 28 on the vehicle steering bar 26 to the PA position 60 and locks it down to this position. Now whenever the operator 22 speaks into the microphone 32 and the headset 44 is connected to the speaker-microphone 40, the operator's speech is broadcast through the PA system 62. If the headset 44 is disconnected from the speaker-microphone 40, the speaker-microphone 40 auto-mute function is disabled and the speech spoken into the speaker-microphone microphone 46 is broadcast through the PA system 62. While in the remote PA mode, if an inbound radio transmission should come in from the portable radio 36 or mobile radio 24, depending on which radio is selected, the inbound transmission is heard by the operator 22 through the either the headset speaker(s) 34 or the speaker-microphone speaker 48, depending on whether or not the headset 44 is connected. While in PA mode, if the operator 22 would like to momentarily mute either the headset microphone 32 or the speaker-microphone microphone 46, the operator 22 presses the mute button 63 on the speaker-microphone 40. As long as the mute button 63 is held down, the microphone that is currently being used is muted. When in PA mode, if the operator 22 would like to transmit over the portable radio 36, the operator 22 presses the PTT switch 38 on the speaker-microphone 40 and speaks into the headset microphone 32 or the speaker-microphone microphone 46 depending on whether the headset 44 is connected to the speaker-microphone 40 or not. Pressing the speaker-microphone PTT switch 38 overrides the PA mode functionality, so that no broadcasts are made through the PA system 62, and the operator's speech is transmitted through the portable radio 36.

C. Maintenance

No regular maintenance of the system is required. The system may run off of the vehicle's battery 86 and the portable radio's battery 88 so there is no requirement to charge an internal battery in the speaker-microphone 40 from an external power source in order to power the operator module assembly 23.

D. Frequency Selection

In order to avoid operators of different vehicles from interfering with each other, each system can be set to different operating frequencies. This ability to have different frequencies allows for numerous operators to use their communications devices in close proximity without any interference. The frequency selection is made by selecting a particular frequency on a switch. The vehicle control module frequency switch 90 and the speaker-microphone frequency switch 92 both must be set to the same frequency setting in order for the system to operate properly. Exemplary frequencies include, for example, the 902 to 928 MHz frequency range and the 2.4 GHz frequency band (as used, for example, by the Bluetooth communications standards).

E. Accessories

Attaching an ear bud speaker 64 simply requires plugging in the ear bud speaker 64 to the ear bud speaker port 66 on the speaker-microphone 40. This mutes the speaker-microphone speaker 48. The same procedure is used to connect a cellular telephone 70 or personal entertainment device 68 to the system except that they would be plugged into the cellular telephone port 69 and entertainment audio port 67, respectively.

The following briefly describes some features of alternative embodiments of the invention.

Mobile and Portable Radios without Public Address System Interface. Similar system as described above except that the PA mode functionality is not included.

Portable Radio Only with Public Address System Interface. Similar system as described above except that there is no interface to a mobile radio. All inbound and outbound radios transmissions are through the portable radio whether the operator in or out of the vehicle. PA mode functionality is the same as described above.

Mobile-only with PA. Similar system as described above except that there is no interface or usage of a portable radio. An alternate power source for the on-person components of the system would be supplied. In addition, all communications would be through the mobile radio whether the operator is in or out of the vehicle.

Mobile-only. Similar system as “Mobile-only with PA” above, except that there is no interface to the PA.

Remotely Turn on the PA System. Instead of turning the remote PA functionality on at the vehicle, the system would have ability to remotely activate the PA within the range of the wireless system.

Automatic Frequency Selection. Instead of having to manually select the frequency, the system would automatically select a frequency from which to work in order to avoid interference with other systems being used within range of the system.

Interface to Multiple Mobile Radios. Similar system as described above except that there could be more than one mobile radio which the system interfaces to. Similarly, the system could interface to multiple portable radios.

Superposition of Audio Streams. The user may wish to listen simultaneously to multiple audio streams. One audio stream may come, for example, from a portable radio and the other from a mobile radio. Alternatively, if the system of the invention interfaces to multiple mobile radios, two audio streams may for example come from mobile radios.

The superposition of the audio streams is easily implemented by standard techniques of electronics. For example, analog summation of the audio streams using an analog adder circuit may be employed. Alternatively, the two audio streams may be digitized in the form of samples and may be added digitally.

The ability to interface to multiple audio streams may be useful in particular circumstances. An example is a police motorcycle officer who wants to hear a dispatch channel over the mobile radio and also have the ability to hear a tactical channel over the portable radio at the same time.

[Standard Material at End of Application]

It is to be understood that while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties. However, where a patent, patent application, or publication containing express definitions is incorporated by reference, those express definitions should be understood to apply to the incorporated patent, patent application, or publication in which they are found, and not to the remainder of the text of this application, in particular the claims of this application.

We claim:

1. A communications system for a vehicle user, comprising:
a portable transceiver which the vehicle user can easily carry on his or her person and a vehicle-mounted transceiver,
wherein the portable transceiver is capable of communicating with the vehicle-mounted transceiver and
wherein audio information contained in a transmission from the portable transceiver may be retransmitted by the vehicle-mounted transceiver either to a public address system or to a second vehicle-mounted transceiver.

2. The communications system of claim 1, wherein the portable transceiver is helmet mounted.

3. The communications system of claim 1, wherein the portable transceiver is mounted in a speaker-microphone enclosure.

4. The communications system of claim 1, further comprising a helmet-mounted speaker or a helmet-mounted microphone or both.

5. The communications system of claim 1, further comprising a lapel speaker-microphone.

6. The communications system of claim 1, wherein the vehicle is a motorcycle.

7. The communications system of claim 1, wherein the vehicle is a fire apparatus.

8. The communications system of claim 1, wherein the communication to the vehicle mounted transceiver can take place with the user up to 1,500 feet from the vehicle and with acceptable quality transmission of the audio information.

9. The communications system of claim 1, wherein the audio information is modulated onto the transmission from the portable transceiver using one or more of amplitude modulation, frequency modulation, and phase modulation.

10. The communications system of claim 1, further comprising a second portable transceiver which is capable of transmitting over a public safety radio system and receiving information transmitted by other transmitters over the public safety radio system.

11. The communications system of claim 10, further comprising a switch for changing easily between a mode in which the second portable transceiver is used for public safety radio system communications and a mode in which the portable transceiver in tandem with the vehicle mounted transceiver are used for public safety radio system communications through a second vehicle-mounted radio transceiver.

12. The communications system of claim 1, wherein at least some communication between the portable transceiver and the vehicle-mounted transceiver takes place over the frequency range of about 902 MHz to about 928 MHz.

13. The communications system of claim 1, wherein at least some communication between the portable transceiver and the vehicle-mounted transceiver takes place in a 2.4 GHz frequency band.

14. The communications system of claim 13, wherein at least some communication between the portable transceiver and the vehicle-mounted transceiver takes place in conformance with Bluetooth standards.

15. The communications system of claim 1, wherein at least some communication between the portable transceiver and the vehicle-mounted transceiver takes place in a 5.8 GHz frequency band.

16. The communications system of claim 10, wherein the portable transceiver and the second portable transceiver run off a single battery.

17. The communications system of claim 1, wherein the user can both transmit and receive over the second vehicle-mounted radio transceiver while on or in the vehicle.

18. The communications system of claim 1, wherein the user may communicate over a wired mode with the second vehicle-mounted radio transceiver in addition to communicating via the portable transceiver.

19. The communications system of claim 1, wherein the user may hear multiple audio streams superposed.

20. A method of communicating with a vehicle user, comprising (a) by means of a first transceiver mounted on a vehicle used by the user, receiving a first radio signal containing audio information, (b) transforming the first radio signal to produce a second radio signal containing substantially the same audio information, (c) by means of a portable transceiver mounted on the user's person, receiving the second radio signal and demodulating it to produce an audio signal, (d) energizing with the audio signal at least one speaker so that the user perceives audio information contained in the first radio signal, (e) capturing by means of a microphone additional audio information resulting from words said by the user, (f) by means of the portable transceiver, generating a third radio signal containing the audio information resulting from words said by the user, and (g) in response to the third radio signal, either playing the audio information in the third radio signal on a public address system, or transmitting that audio information in a fourth radio signal.

21. A vehicle-mounted communications system, comprising:
a first transceiver capable of exchanging information via radio signals with a portable transceiver which can be easily carried on a vehicle user's person and capable of driving a public address system mounted on the vehicle,
a second transceiver capable of exchanging information with the first transceiver and via radio signals with a central two-way radio communications system,
wherein audio information in signals received by the second transceiver from the central two-way radio communications system can be relayed by the second transceiver via radio to the portable transceiver.

22. The system of claim 21, wherein the portable transceiver can control whether the first transceiver drives the public address system or relays audio information to or from the second transceiver.
